(19) United States
(12) Patent Application Publication
(10) Pub. No.: US 2011/0094380 A1
(43) Pub. Date: Apr. 28, 2011

(54) ULTRA-THIN CO2 SELECTIVE ZEOLITE MEMBRANE FOR CO2 SEPARATION FROM POST-COMBUSTION FLUE GAS

(75) Inventors: Shiguang Li, Mount Prospect, IL (US); Qinbai Fan, Chicago, IL (US)

(73) Assignee: GAS TECHNOLOGY INSTITUTE, Des Plaines, IL (US)

(21) Appl. No.: 12/607,639

(22) Filed: Oct. 28, 2009

(51) Int. Cl. B01D 53/22; C01B 39/02; B01J 29/06; B01J 29/072

(52) U.S. Cl. 95/51; 423/709; 502/60; 502/74; 95/45

(57) ABSTRACT

A method for producing a crystalline silicoaluminophosphate (SAPO) membrane in which a porous support is contacted with SAPO seed crystals to form a SAPO seeded porous support. The SAPO seeded porous support is filled with an aqueous SAPO synthesis gel including a mixture of sources of aluminum, phosphorus, silicon, oxygen, water, and a templating agent, forming a gel-filled porous structure which is then heated to form a SAPO layer of SAPO crystals on a surface of and/or within pores of the porous support. The SAPO layer is calcined, thereby removing the templating agent and forming a supported porous SAPO membrane layer, which is then subjected to a pore size reduction post-synthesis treatment process, producing a reduced pore size supported porous SAPO membrane layer having an average pore size of less than about 0.38 nm.

### BACKGROUND OF THE INVENTION

1. Field of the Invention

This invention relates to silicoaluminophosphate (SAPO) membranes. More particularly, this invention relates to SAPO membranes supported on porous supports. This invention further relates to SAPO membranes for selective separation of gases in a gas mixture. This invention further relates to supported SAPO membranes and methods for producing such membranes.

2. Description of Related Art

One of the more significant contributors to global warming is the emission of greenhouse gases, particularly carbon dioxide (CO₂), into the atmosphere. The primary sources of CO₂ emissions are fossil fuel combustion, natural gas sweetening, synthesis gas production and certain chemical plants. The United States is committed to reducing the greenhouse gas intensity of the American economy by 18% over the 10-year period from 2002 to 2012.

Low-temperature distillation is a widely used commercial process for purification and liquefaction of CO₂ from streams containing CO₂ fractions larger than 90%. However, with atmospheric pressure flue gases, CO₂ cannot be effectively condensed. Alkaline sorbents and scrubbing solutions are also employed to remove CO₂ from various gas mixtures. Compared to these methods, membrane separation processes are far less expensive, require less energy to operate, and do not need chemicals or regenerating absorbents to maintain. Additionally, membranes are compact and can be retrofitted onto the tail end of power-plant flue gas streams without complicated integration. Permeance and selectivity are two of the basic characteristics or properties of membranes which are useful for determining the potential of a membrane for gas separations.

For the separation of CO₂ from the flue gas, it has been reported that a CO₂/N₂ selectivity of >70 and a minimum CO₂ permeance of 3.3×10⁻⁷ mol/(m²·s·Pa) or 1,000 GPU (GPU is an industrial unit equivalent to 10⁻⁶ cm³(STP)/(cm²·s·cmHg)) are required for the economic operation. The driving force across a gas-separation membrane is the pressure differential between the feed side and the permeate side. Creating this driving force accounts for most of the cost for membrane separation since flue gases are at or slightly above atmospheric pressure. The majority of previous studies have compressed the feed gas to a higher pressure (15 to 20 bar) and set the permeate stream at atmospheric pressure (designated as pressurized feed/atmospheric permeate mode). Under this mode, the feed-gas and the post-separation compressors account for over 50% of the capital and operating costs. To reduce the cost of compressing, another approach is to leave the feed gas close to atmospheric pressure and use vacuum to draw the permeate (designated as atmospheric feed/vacuum permeate mode). Using this mode, it has been estimated that the cost of capturing CO₂ using gas-separation membranes is only about 65% of the cost using a pressurized feed.

Polymeric membranes have been successfully applied for the separation of CO₂ from natural gas streams. However, they have limitations for flue gas application because of their poor performance, stability at high temperature, and their intolerance to harsh chemicals. Although flue gases can be cooled prior to a separation, the associated energy consumption increases the cost. Therefore, the CO₂ permeances and CO₂/N₂ selectivities of polymeric membranes need to be significantly improved to lower the total cost. An alternative approach is to develop membrane materials that are inherently stable at higher temperatures and harsh chemicals. Molecular sieve materials (such as zeolite) are one such class of materials for highly selective membranes that overcome problems associated with existing polymer materials, and that offer an opportunity to expand membrane technology.

Zeolite membranes are multi-crystalline materials synthesized as a dense layer on the surface of a porous support (α-Al₂O₃, γAl₂O₃, or stainless steel) and/or within the pores of the support. The porous support can be thick but with large pores (0.1-5 μm). They provide mechanical strength without introducing additional mass transfer resistance. Because the zeolite membrane is an inorganic oxide and the underlying support is a ceramic or metal, these membranes are far more robust than conventional polymeric membranes and they are usable in high-pressure environments. In addition, these membranes are stable to at least 400° C. as well as in chemically corrosive conditions. In addition to their robustness, zeolite membranes are of interest because they are able to separate gas mixtures with high selectivity. Depending upon the type of zeolite, the mixture system, and the operating conditions, mixtures are separated in accordance with at least the following three principles or mechanisms: 1) molecular sieving, where larger molecules are unable to fit into the pores, and thus the smaller molecules preferentially permeate; 2) differences in diffusivity, where the smaller, less hindered type of molecule in a mixture diffuses faster than the larger ones; and 3) competitive adsorption, where one type of molecule is more strongly adsorbed on the zeolite and thus can dramatically inhibit permeation of another type of molecule. Separation selectivity depends on the particular zeolite used for the membrane, its chemical composition (e.g., Si/Al ratio), the crystal orientation, the identity of the charge neutralization ion, and the quality of the membrane. The kinetic diameters of CO₂ and N₂ are 0.33 nm and 0.364 nm, respectively. Thus, to obtain a high CO₂ flux, by way of differences in diffusivities responsible for the CO₂/N₂ selectivity, zeolite membranes should have pore sizes (diameters) in the range of about 0.35-0.55 nm. SAPO-34 membranes, which have pore sizes of 0.38 nm, have been shown to be effective for removal of CO₂ from natural gas with CO₂/CH₄ separation selectivities higher than 170, CO₂ permeances as high as about 2×10⁻⁶ mol/(m²·s·Pa) at 22° C., and a feed pressure of 224 kPa.

SAPO-34 is a silicoaluminophosphate having the composition SiₓAl_{y}P_{z}O₂ where x=0.01-0.98, y=0.01-0.60, and z=0.01-0.52. The SAPO-34 structure is formed by substituting silicon for phosphorous in the AlPO₄ which has a neutral framework and exhibits no ion exchange capacity. SAPO-34 has been found to be highly stable in humid atmospheres at temperatures over 100° C. Below this temperature, 2 days of hydration reduces the crystallinity and porosity, but they are completely recovered by calcination in a dry environment.

However, for other CO₂-containing mixtures, there remains a need for improved methods for making SAPO membranes, in particular, SAPO membranes having improved separation selectivities for CO₂, in particular over N₂ in flue gas treatment.

### SUMMARY OF THE INVENTION

This invention provides methods for making crystalline silicoaluminophosphate (SAPO) membranes on a porous support. Inorganic membranes such as SAPOs can have superior thermal, mechanical and chemical stability, good erosion resistance, and high pressure stability as compared with conventional polymeric membranes. The methods of this invention can produce SAPO membranes and, in particular, SAPO-34 membranes, having improved CO₂/N₂ selectivities as compared with conventional membranes and which are capable of separating CO₂ from post-combustion flue gas.

This invention describes a method for preparing CO₂ selective zeolite membranes having thicknesses up to about 5 microns supported on mechanically strong substrates, such as ceramic, metal or carbons, to obtain adequate mechanical strength. The membrane is useful for CO₂ capture from post-combustion flue gas, in particular, CO₂/N₂ separations. The major steps used to make the membrane thin and highly CO₂ selective include:

1) Selection of zeolite—The selected zeolites have pores that can discriminate between molecules approx. 0.35-0.5 nm in size. The zeolites also have higher adsorption capacity for CO₂ than N₂, which is useful because adsorbed CO₂ would narrow down membrane pores and further block N₂ through.

2) Seeding the substrates—Homogenous zeolite crystals with sizes smaller than 200 nm are used as seeds in the membrane fabrication. A seeding technique, for example, electrophoretic deposition, is applied to attach nano-sized seed crystals to the substrates.

3) Formation of continuous zeolite layer—The seeded support is placed in a synthesis gel followed by hydrothermal synthesis to obtain the desired zeolite layer and structure. The layer has a low fraction of large non-zeolitic pores (grain boundaries) and is about 1 micron thick.

4) Post-synthesis treatment—To tailor pore structure, membrane is post-treated (for example, by using chemical layer deposition) to systematically reduce the zeolite and possible non-zeolite pore sizes, thereby further decreasing the diffusivity of N₂ and, thus, increasing CO₂/N₂ selectivity.

The membranes produced in accordance with the method of this invention can separate CO₂ from other gases at elevated temperatures because they are thermally stable at temperatures up to 400° C. The transport mechanism for the membrane is based on an adsorption-diffusion mechanism having five steps: 1) adsorption onto the membrane surface; 2) migration into the zeolite micropores; 3) diffusion through the zeolite micropores; 4) migration out of the pores onto the membrane surface; and 5) desorption from the membrane surface. Competitive adsorption and difference in diffusivities are responsible for the high selectivity. The membrane is selective for CO₂ over N₂ because CO₂ is smaller (diffuses faster) and has higher adsorption coverage than N₂. More particularly, the kinetic diameters for CO₂ and N₂ are 0.33 nm and 0.364 nm, respectively. To obtain high CO₂ flux while maintaining the difference in diffusivities responsible for CO₂/N₂ selectivity, the membranes have pore sizes of approximately 0.35 nm to about 0.5 nm in diameter. 8-member ring zeolites are good candidates for CO₂/N₂ separation and, thus, we selected a silicoaluminophosphate zeolite, SAPO-34, which has a composition (SiₓAl_{y}P_{z})O₂, where x=0.01-0.98, y=0.01-0.60, z=0.01-0.52, and x+z=y. It has a chabazite structure with a pore diameter of 0.38 nm (FIG. 1). Adsorption experiments determined that n-C₄H₁₀ (0.43 nm diameter) fits into the SAPO-34 pores whereas i-C₄H₁₀ (0.5 nm diameter) does not. SAPO-34 is often used as a catalyst for light olefin synthesis, such as ethylene synthesis from methanol because of its intermediate acidity and small pore size.

In accordance with one embodiment, the method of this invention comprises the steps of a) providing a porous support; b) preparing a plurality of SAPO seed crystals; c) preparing an aqueous SAPO synthesis gel comprising a mixture of sources of aluminum, phosphorus, silicon, oxygen, water, and a templating agent; d) contacting the porous support with the SAPO seed crystals, forming a SAPO seeded porous support; e) filling the SAPO seeded porous support with the SAPO synthesis gel, forming a gel-filled porous structure; f) heating the gel-filled porous structure, forming a SAPO layer of SAPO crystals on the surface and/or within pores of the porous support; g) calcining the SAPO layer, thereby removing the templating agent and forming a supported porous SAPO membrane layer; and h) subjecting the supported porous SAPO membrane layer to a pore size reduction post-synthesis treatment process, producing a reduced pore size supported porous SAPO membrane layer having an average pore size of less than about 0.38 nm. As used herein, the term “porous” when used to describe the SAPO membranes, including the SAPO-34 membrane, refers to the porosity characteristics of the individual zeolite crystals of which the membrane is formed as opposed to inter-crystal voids that may undesirably exist in the membrane layer.

### BRIEF DESCRIPTION OF THE DRAWINGS

These and other objects and features of this invention will be better understood from the following detailed description taken in conjunction with the drawings, wherein:

FIG. 1 is a diagram of a SAPO-34 structure having a pore diameter of 0.38 nm;

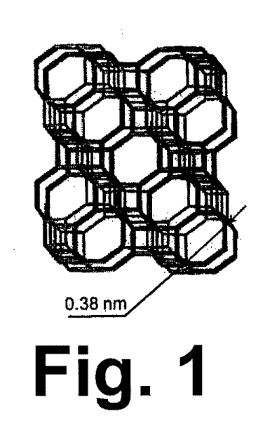

FIG. 2 is a scanning electron micrograph (SEM) showing the shape of SAPO seeds employed in the method of this invention for producing CO₂/N₂ separation membranes;

FIG. 3 is a cross-sectional SEM micrograph of a SAPO-34 membrane on an α-Al₂O₃ produced in accordance with the method of this invention;

FIG. 4 is a diagram showing a comparison of CO₂/N₂ selectivity versus CO₂ permeability for polymeric and SAPO-34 membranes in accordance with one embodiment of this invention at about 22° C.;

FIG. 5 is a diagram showing CO₂ and N₂ fluxes and CO₂ permeate concentration at 22° C. of a CO₂/N₂ mixture (50/50) as a function of feed pressure through a SAPO-34 membrane at a permeate pressure of 102 kPa;

FIG. 6 is a diagram showing CO₂ and N₂ permeances and CO₂/N₂ selectivity of a CO₂/N₂ mixture (50/50) through a SAPO-34 membrane as a function of temperature with a feed pressure of about 240 kPa and a permeate pressure of about 102 kPa;

FIG. 7 is a diagram showing CO₂ and N₂ permeances of single gases and a CO₂/N₂ mixture (50/50) through a SAPO-34 membrane as a function of temperature at a feed pressure of about 102 kPa and the permeate under a vacuum (5 kPa);

FIG. 8 is a diagram showing selectivities and CO₂ permeate concentration of a CO₂/N₂ mixture (50/50) through a SAPO-34 membrane as a function of temperature at a feed pressure of about 102 kPa and the permeate under a vacuum (5 kPa); and

FIG. 9 is a diagram showing a multi-step membrane system using an atmospheric feed/vacuum permeate mode through a SAPO-34 membrane where the permeate pressure is about 5 kPa.

### DETAILED DESCRIPTION OF THE PRESENTLY PREFERRED EMBODIMENTS

SAPO-34 membranes, synthesized on porous α-Al₂O₃ supports by using multiple templates and reduced crystallization time in accordance with one embodiment of the method of this invention, show high CO₂ permeability for separating CO₂/N₂ mixtures up to 230° C. At a trans-membrane pressure drop of 138 kPa and an atmospheric pressure on the permeate side, one such membrane had a CO₂ permeance of 1.2×10⁻⁶ mol/(m²·s·Pa) (=3,500 GPU) with a CO₂/N₂ separation selectivity of 32 for a 50/50 feed at 22° C. At a feed pressure of 23 bar, the CO₂ flux was as high as 75 kg/(m²·h). CO₂/N₂ separations were investigated in part by using vacuum permeate pumping, whereby the membrane showed a CO₂ permeance of 7.7×10−7 mol/(m²·s·Pa) and a CO₂ permeate concentration of 93% for an equimolar feed at 22° C. For a 10% CO₂/90% N₂ feed, to reach a CO₂ permeate concentration of 99%, only three steps were required at 22° C. and 4 steps required at 110° C.

The membranes of this invention are formed by crystallization of an aqueous silicoaluminophosphate-forming gel containing an organic templating agent. The term “templating agent” or “template” is a term of art meaning a species added to the synthesis media to aid in and/or guide the polymerization and/or organization of the building blocks that form the crystal framework. Gels for forming SAPO crystals are known to those versed in the art, but preferred gel compositions for forming membranes may differ from preferred compositions for forming loose crystals. The preferred gel composition may vary depending upon the desired crystallization temperature.

### Membrane Synthesis and Characterization

SAPO-34 membranes were prepared by secondary growth onto a tubular porous α-Al₂O₃(0.2-μm pores) structure. The permeate area was approximately 5.5 cm². Before synthesis, the supports were boiled in deionized water for 1 h and dried at 150° C. for 30 min.

### SAPO-34 Seeds Synthesis

In accordance with one exemplary embodiment of the method of this invention, 6.8 gm of Al(i-C₃H₇O)₃ (>99%, Aldrich), 3.85 gm of H₃PO₄ (85 wt % aqueous solution, Aldrich) and 20 gm of deionized H₂O were mixed together and stirred for 2 hrs to form an homogeneous solution. Then, 1.13 gm of Ludox AS-40 colloidal silica (40 wt % suspension in water, Sigma-Aldrich) was added to the stirred mixture and the resulting solution was stirred for 0.5 hrs. Next, 12.3 gm of tetraethylammonium hydroxide (20 wt % solution in water, Sigma-Aldrich) was added and the solution was stirred for another 0.5 hrs. Finally, 1.37 gm of dipropylamine (99%, Aldrich) and 1.34 gm of cyclohexylamine (99%, Sigma-Aldrich) were added and the solution stirred for 12 hrs at room temperature. The resulting solution was placed in an autoclave, and treated hydrothermally at 220° C. for 12 hrs, producing SAPO seeds. After cooling to room temperature, the seeds were centrifuged at 2,200 rpm for 20 minutes and washed with water. This procedure was repeated 4 times. The resultant precipitate was dried overnight and calcined at 500° C. for 5 hrs. The calcination heating and cooling rates were 1.0° C./min.

### SAPO-34 Membranes Synthesis

The synthesis gel molar ratio was 1.0 Al₂O₃:1.0 P₂O₅:0.45 SiO₂:1.2 TEAOH:1.6 dipropylamine:100 H₂O. In accordance with one exemplary embodiment of the method of this invention, Al(i-C₃H₇O)₃, H₃PO₄ and deionized H₂O were mixed together and stirred for 0.5 hrs to form an homogeneous solution to which Ludox AS-40 colloidal silica was added and the resulting solution stirred for another 0.5 hrs. Then, tetraethylammonium hydroxide and dipropylamine were added, and the solution stirred for 12 hrs at room temperature. The membranes were prepared by rubbing the inside surface of a porous α-Al₂O₃ support with dry, calcined SAPO-34 seeds. The rubbed porous supports, with their outside wrapped with Teflon tape, were then placed in an autoclave and filled with synthesis gel. The hydrothermal treatment was carried out at 220° C. for 2-6 hrs, after which the membranes were washed with deionized water. The membranes were calcined in air at 390° C. for 10 hrs to remove the templates. The calcination heating and cooling rates were 0.6° C./min.

### Membrane Characterization

Powders were collected during the membrane synthesis, calcined at 550° C. for 8 hrs, and used for gas adsorption. Isotherms for CO₂ and N₂ were measured with pressure steps of approximately 10 bar. The samples were evacuated for 24 hrs or until no changes were observed in the mass anymore. One membrane was broken and analyzed by scanning electron microscopy (SEM).

### Gas Permeation and Separation

Single-gas and mixture permeations were measured in a flow system. The membranes were mounted in a stainless steel module and sealed at each end with silicone o-rings. Mass flow controllers were used to mix pure CO₂ and N₂ gases. The pressure on each side of the membrane was independently controlled. The membrane module was placed in an oven so that separation could carry out at elevated temperatures (up to 250° C.). Fluxes were measured using a bubble flow meter. The compositions of the feed and permeate streams were measured by a CARLE Series 400 gas chromatograph equipped with a thermal conductivity detector and HAYESEP-A column. The oven was kept at 60° C. The permeance of the component i, Pᵢ, is:

$${P}_{i} = \frac{{J}_{i}}{Δ {P}_{ln i}} \qquad ( 1 )$$

For the cross-flow configuration, because one component preferentially permeates through the membrane, the partial pressures in the feed and retentate are quite different. A Log-mean pressure drop was calculated by

$$Δ {P}_{ln , i} = \frac{( {p}_{f , i} - {p}_{r , i} )}{ln [ ( {p}_{f , i} - {p}_{p , i} ) / ( {p}_{r , i} - {p}_{p , i} ) ]} \qquad ( 2 )$$

where Jᵢ is the flux through the membrane for component i; p_{f,i}, p_{r,i} and p_{p,i} are partial pressures for component i, in feed, retentate, and permeate sides, respectively. The permeability is the permeance multiplied by membrane thickness. The ideal selectivity is the ratio of the single-gas permeances, and the separation selectivity, α_{i/j}^{sep}, is the ratio of the permeances for mixtures.

### Results and Discussion

### Characterization

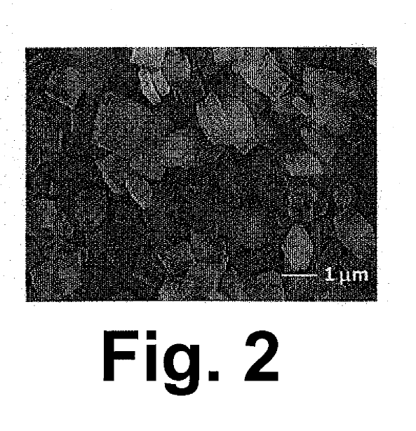

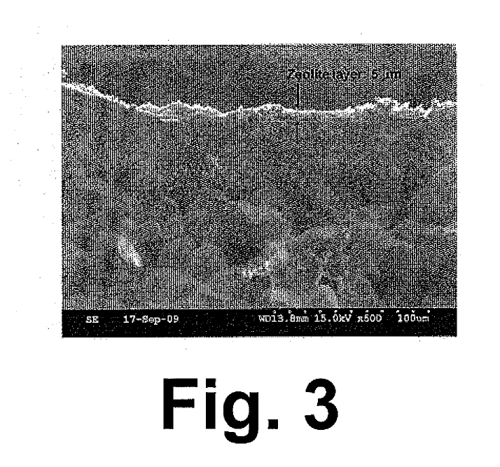

The SAPO-34 seeds used to synthesize membranes were cubic and rectangular crystals with sizes ranging from 0.5 to 1.2 μm (FIG. 2). SAPO-34 membranes were prepared with one synthesis step by using reduced crystallization time. The cross-sectional SEM micrograph of a SAPO-34 membrane prepared with a crystallization time of 6 hrs shows a continuous zeolite layer approximately 5 μm thick (FIG. 3).

### Effect of Crystallization Time

Membrane M1, as shown in Table 1, prepared with a crystallization time of 6 hrs had a CO₂/N₂ separation selectivity of 32 with CO₂ permeances of 1.2×10⁻⁶ mol/(m²·s·Pa) at 22° C. and under a feed pressure of 240 kPa and atmospheric permeate. Decreasing the crystallization time to 4 hrs (membrane M2) increased the concentration of non-zeolite pores and, thus, decreased the CO₂/N₂ selectivity. However, its permeance was high as 1.5×10⁻⁶ mol/(m²·s·Pa) under the same test conditions. The higher CO₂ permeance for membrane M2 was because it was thinner than M1. Further decreasing of the crystallization time to 2 hrs (membrane M3) failed to produce a CO₂ selective membrane. It appears that a continuous layer was not formed during such a short crystallization time. It should be noted that the permeances in GPU for M1 (3,500) and M2 (4,500) were much higher than that required for economic industrial operation (100).

TABLE 1
Comparison of CO₂/N₂ separations through SAPO-34
membranes prepared with different crystallization times.

| | Crystallization | Permeance | | Separation |
|---|---|---|---|---|
| Membrane | Time (hrs) | mol/(m² · s · Pa) | GPU* | Selectivity |
| M1 | 6 | 1.2 × 10⁻⁶ | 3,500 | 32 |
| M2 | 4 | 1.5 × 10⁻⁶ | 4,500 | 21 |
| M3 | 2 | IM** | IM | 1 |

*GPU is a unit used in industry, 1 GPU = 10⁻⁶ cm³(STP)/(cm² · s · cmHg);
**IM: immeasurable

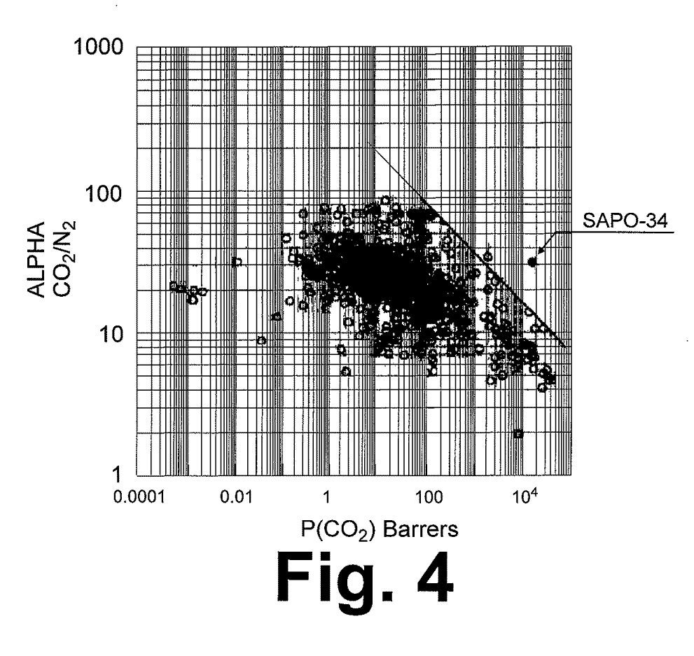

Robeson, L. M., “The upper bound revisited”, J. Membr. Sci., 2008, 320, 390, describes recent revisions to the upper bound for CO₂/N₂ separation selectivities versus CO₂ permeabilities (permeance×membrane thickness) of polymeric membranes at about 22° C. (FIG. 4). It should also be noted that the unit for CO₂ permeability is Barrer, named after Richard Barrer, which is a non-SI unit of gas permeability used in the industry. One Barrer equals 3.348×10⁻¹⁹ kmol·m/(m²·s·Pa). For comparison, data for SAPO-34 membrane M1 is also shown in FIG. 4. Surprisingly, the data point for the SAPO-34 membrane is significantly above this upper bound. The SEM thickness (5 μm) was used to calculate the permeability for FIG. 4, but the effective thickness could be greater if zeolite crystals formed inside the support pores, or it could be less if intergrowth in the zeolite layer was not complete. Thus, the data point in FIG. 4 for the SAPO-34 membrane M1 could move to the right or left.

### CO₂/N₂ Separations Using Pressurized Feed/Atmospheric Permeate

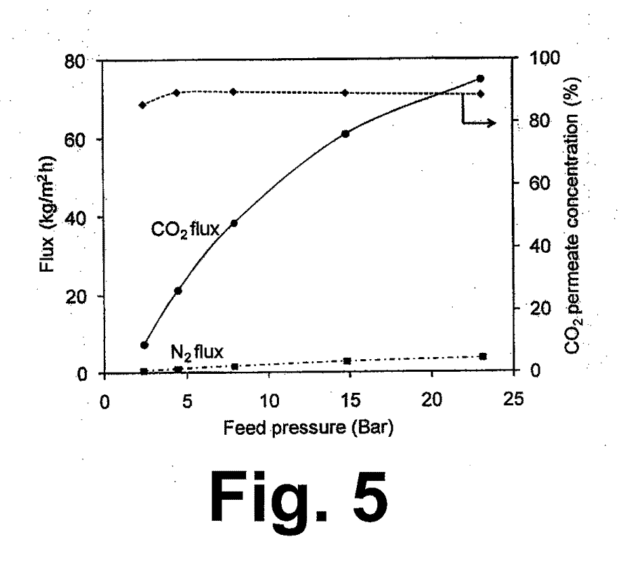

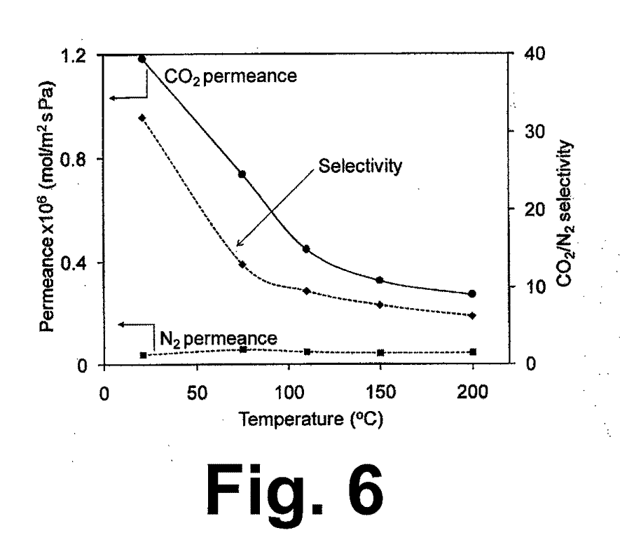

FIG. 5 shows CO₂ and N₂ fluxes for membrane M2 at 22° C. for an equimolar CO₂/N₂ mixture with permeate pressure held at 102 kPa. Both CO₂ and N₂ fluxes increased with feed pressure due to the increases in adsorption coverage. Carbon dioxide permeates faster than N₂ through membrane M2 because the smaller CO₂ diffuses faster and it has higher adsorption coverages than N₂. At a feed pressure of 23 bar, the CO₂ flux was as high as 75 kg/(m²·h). The CO₂ permeate concentration increased from 85.8% to 89.5% as feed pressure increased from 2.4 to 4.5 bar, and remained almost constant at higher feed pressures. FIG. 6 shows CO₂ permeance and CO₂/N₂ separation selectivity through membrane M1 as a function of temperature. As the temperature increases, the CO₂ adsorption coverage decreases and CO₂ less effectively inhibits N₂ adsorption. Thus, CO₂/N₂ separation selectivity decreased. However, the membrane still had a CO₂/N₂ separation selectivity of 6.2 at 200° C. At a typical supercritical bituminous power-plant flue gas temperature of 110° C., membrane M1 had a CO₂ permeance of 4.5×10⁻⁷ mol/(m²·s·Pa) and a CO₂/N₂ separation selectivity of 10. To our knowledge, zeolite membranes with CO₂/N₂ selectivity>5 at temperatures higher than 100° C. have not been reported.

### CO₂/N₂ Separations Using Atmospheric Feed/Vacuum Permeate

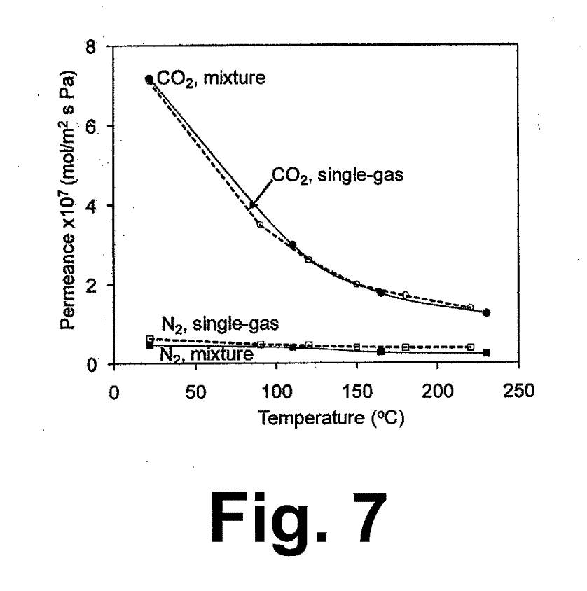

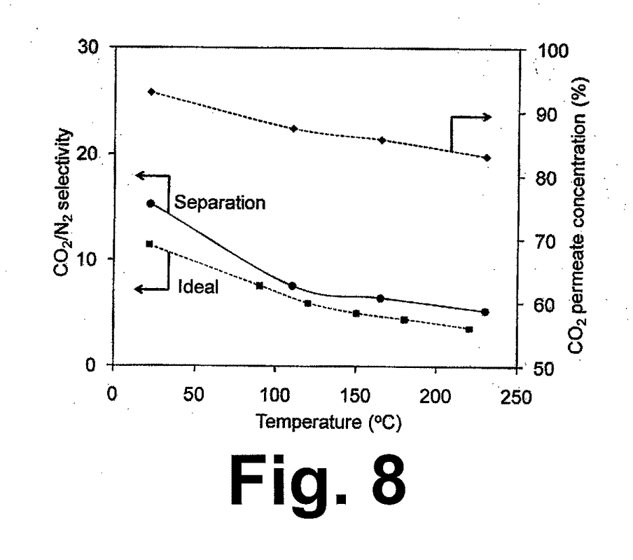

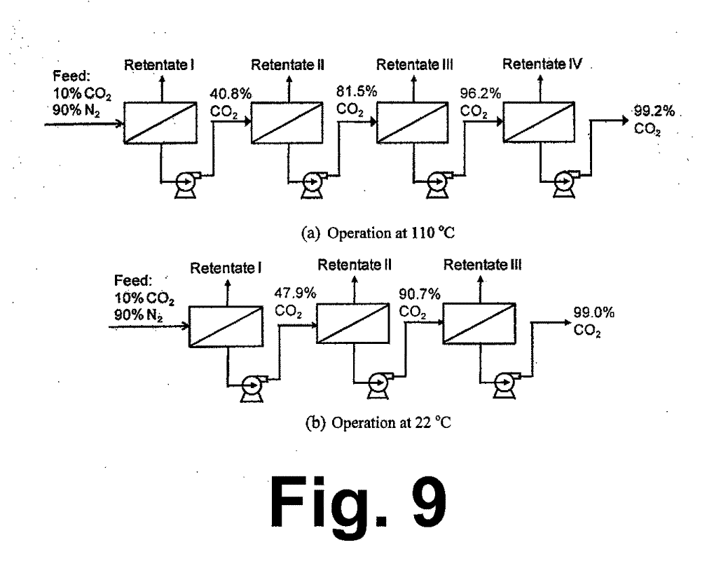

The CO₂/N₂ separation properties of the membrane were also evaluated with the feed gas at atmospheric pressure while drawing the permeate under a 5 kPa vacuum. As shown in FIG. 7, over the temperature range of 22° C. to 230° C., both CO₂ and N₂ permeances in single gases and an equimolar CO₂/N₂ mixture decreased as the temperature increased from 22° C. to 230° C. The CO₂ permeances were identical for single gas and mixture. The N₂ permeance was slightly higher for a single gas than a gas mixture, indicating that CO₂ slightly inhibited N₂ adsorption in the mixture. As a result, the separation selectivity was a bit higher than the ideal selectivity (FIG. 8). At 22° C., the CO₂ permeate concentration was 93%, and the CO₂ flux was 5.2 kg/(m²·h)(CO₂ permeance=7.7×10⁻⁷ mol/(m²·s·Pa). This flux is higher than most pervaporation fluxes through zeolite membranes, even though the driving force is low. The CO₂ concentration in the permeate decreased with temperature as shown in FIG. 8, but it was still as high as 83% at 230° C. At 110° C., the CO₂/N₂ separation selectivity was 8 and CO₂ permeance was 3×10⁻⁷ mol/(m²·s·Pa). CO₂ concentrations in flue gases are generally about 10-15%. In an attempt to maximize CO₂/N₂ separation, multi-step membrane systems under vacuum condition were investigated for membrane M1 at 22° C. and 110° C. using a 10% CO₂/90% N₂ feed. As shown in FIG. 9(a), at 110° C., the CO₂ permeate concentrations were 40.8%, 81.5%, 96.2% and 99.2% respectively, after using the first, second, third and fourth membrane separations. The membrane was more selective at 22° C., and thus only three steps were required to reach a CO₂ permeate concentration of 99% (FIG. 9(b)).

### Comparison to Zeolite Membrane Reported in the Literature

Large-pore, medium-pore, and small-pore zeolite membranes have been reported for CO₂/N₂ separation. Table 2 compares CO₂ permeances and CO₂/N₂ selectivities with known membranes.

TABLE 2
Comparison of CO₂/N₂ separations through zeolite membranes

| | Pore | | | |
|---|---|---|---|---|
| | diameter | | Permeance | |
| Membrane/support | (nm) | Temp. (° C.) | (mol/m² · s · Pa) | Selectivity |
| FAU/alumina tube | 0.74 | 30 | 0.4-3 × 10⁻⁷ | 20-100 |
| FAU/alumina disk | 0.74 | 50 | 3.9 × 10⁻⁸ | 20 |
| Silicalite-1/stainless | 0.55 | 20 | 7.0 × 10⁻⁷ | 68 |
| steel net | | | | |
| Na-ZSM-5/alumina tube | 0.55 | 35 | 1.0 × 10⁻⁷ | 40 |
| NaA/carbon | 0.42 | 22 | 3.4 × 10⁻⁷ | 6.0* |
| T-type/mullite tube | 0.41 | 35 | 4.6 × 10⁻⁸ | 107 |
| DDR/alumina tube | 0.36 × 0.44 | 30 | 6.0 × 10⁻⁸ | 20** |
| SAPO-34/alumina tube | 0.38 | 22 | 1.2-1.5 × 10⁻⁶ | 21-32 |

*Ideal selectivity based on single-gas permeations
**CO₂/air separation

In contrast to the known membranes, the SAPO-34 membranes of this invention have a high potential for CO₂ capture in flue gas treatment since their CO₂ permeances are about 1-2 orders of magnitude higher than other known small-pore zeolite membranes. Even at 110° C., the permeances for the membranes of this invention, either using the pressurized feed/atmospheric permeate mode (4.5×10⁻⁷ mol/(m²·s·Pa)) as shown in FIG. 6 or using the atmospheric feed/vacuum permeate mode (3×10⁻⁷ mol/(m²·s·Pa)) as shown in FIG. 7, generally meet the requirement for economic industrial operation. It should be noted that sensitivity studies indicate that high CO₂ permeance is much more important than high selectivity in lowering the cost of CO₂ capture.

The unique material properties and the progress in separation performance of SAPO-34 membranes offer several advantages over currently available membrane technologies for CO₂ capture from flue gases. One advantage is the ability to operate continuously at higher temperatures with high flux. The second, but equally important, advantage is the improvement of CO₂/N₂ separation performance provided by post-synthesis treatment of the membranes to reduce the SAPO pores from their normal (natural) 0.38 nm size to less than 0.364 nm (the kinetic diameter of N₂) so as to enhance the differences in diffusivity and molecular sieving in the separation process. The post-synthesis treatment is the key step to produce zeolite membranes with high CO₂/N₂ selectivity. In some cases, this treatment leads to blockage of non-zeolite pores (grain boundaries). In other cases, it models the zeolite pore size. By virtue of the reduction in pore size afforded by the post-synthesis treatment step, nitrogen may still fit into the pores of the treated membrane, but its permeation is expected to be inhibited more than CO₂. Thus, CO₂/N₂ selectivity can be improved. Possible post-synthesis treatment methods are described herein below. However, any post-synthesis method which reduces the pore size of the membrane without affecting the integrity of the membrane may be employed. Methods may also be combined to take advantage of the features that each may offer.

In accordance with one embodiment of this invention, the post-synthesis treatment is an ion-exchange method in which the SAPO-34 structure is generally formed by substituting silicon for phosphorous in AlPO₄, which has a neutral framework and exhibits no ion exchange capacity. Silica is tetravalent and, thus, the substitution creates acid sites that can be exchanged with alkali cations such as Li⁺, Na⁺, K⁺, NH₄⁺, or Cu²⁺. The ion-exchange causes steric hindrance or pore narrowing by the adsorbed cations, and thus decreases the permeance of the bigger molecule more than that of the smaller molecule, thereby improving CO₂/N₂ selectivity.

In accordance with another embodiment of this invention, the post-synthesis treatment is a silylation method in which silane (SiH₄) is used to treat the SAPO-34 membranes. Adsorption experiments have determined that n-C₄H₁₀ (0.43 nm kinetic diameter) fits into the SAPO-34 pores, but i-C₄H₁₀ (0.5 nm diameter) does not. SiH₄ has a kinetic diameter of 0.41 nm, and would therefore fit into the SAPO-34 pores. In this process, the reactants SiH₄ and O₂ are respectively fed outside and inside of the membrane layer. The SiH₄ and O₂ counter diffuse through the pores, and upon reaction, deposit on the wall of the non-zeolite pores and on the mouth of the zeolite pores. Eventually, this self-limiting diffusion controlled process reduces the sizes of all pores.

In accordance with yet another embodiment of this invention, the post-synthesis treatment is a gas or liquid vapor chemisorption process in which the chemisorptions of gas or liquid on the SAPO pores decreases the fraction of non-SAPO pores. It could also decrease the size of zeolite pore opening.

In summary, the SAPO-34 membranes of this invention have high potential for CO₂ capture in flue gas treatment. The membranes, synthesized on porous α-Al₂O₃ supports by using multiple templates and reduced crystallization time, showed high CO₂ permeance for separating CO₂/N₂ mixtures up to 230° C. At a trans-membrane pressure drop of 138 kPa and an atmospheric pressure in the permeate side, the membranes had a CO₂ permeances of 1.2×10⁻⁶ mol/m²×s·Pa (3,500 GPU) with CO₂/N₂ separation selectivity of 32 for a 50/50 feed at 22° C. At a feed pressure of 23 bar, the CO₂ flux was as high as 75 kg/(m²·hr). CO₂/N₂ separations were also effective when using vacuum permeate pumping and leaving the feed at atmospheric pressure. For a 10% CO₂/90% N₂ feed, at 22° C., only three steps were required to reach a CO₂ permeate concentration of 99%. For such a high-flux membrane, even at 110° C., the CO₂ permeances generally meet the requirement for the economic industrial operation. The CO₂/N₂ separation selectivity, however, needs to be further improved by post-synthesis treatment.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A method for producing a crystalline silicoaluminophosphate (SAPO) membrane comprising the steps of:
providing a porous support;
preparing a plurality of SAPO seed crystals;
preparing an aqueous SAPO synthesis gel comprising a mixture of sources of aluminum, phosphorus, silicon, oxygen, water, and at least one templating agent;
contacting said porous support with said SAPO seed crystals, forming a SAPO seeded porous support;
filling said SAPO seeded porous support with said SAPO synthesis gel, forming a gel-filled porous structure;
heating said gel-filled porous structure, forming a SAPO layer of SAPO crystals at least one of on a surface of said porous support and within pores of said porous support;
calcining said SAPO layer, thereby removing said templating agent and forming a supported porous SAPO membrane layer; and
subjecting said supported porous SAPO membrane layer to a pore size reduction post-synthesis treatment process, producing a reduced pore size supported porous SAPO membrane layer having an average pore size of less than about 0.38 nm.

2. The method of claim 1, wherein said SAPO seed crystals have a size of less than about 500 nm.

3. The method of claim 1, wherein said porous support is made of a material selected from the group consisting of stainless steel, carbon, glass, ceramics, and combinations thereof.

4. The method of claim 1, wherein said reduced pore size porous supported SAPO membrane layer has a thickness in a range of about 0.2 μm to about 5 μm.

5. The method of claim 1, wherein said porous support has pore sizes in a range of about 0.1 μm to about 5.0 μm.

6. The method of claim 1, wherein said reduced pore size SAPO membrane layer comprises SAPO crystals having a surface area in a range of about 300 to about 800 m²/gm.

7. The method of claim 1, wherein said SAPO is SAPO-34.

8. The method of claim 7, wherein said SAPO-34 is a silicaluminophosphate having a composition of SiₓAl_{y}P_{z}O₂ where x=0.01-0.98, y=0.01-0.60, and z=0.01-0.52.

9. The method of claim 1, wherein said gel-filled porous structure is heated for a time period in a range of about 2 hours to about 24 hours.

10. The method of claim 1, wherein said SAPO layer is calcined in air for a time period less than or equal to about 10 hours.

11. The method of claim 1, wherein said post-synthesis treatment process is selected from the group of processes consisting of ion-exchange, silylation, gas chemisorption, liquid vapor chemisorption, and combinations thereof.

12. The method of claim 10, wherein said SAPO layer is calcined at a temperature of about 390° C.

13. The method of claim 1, wherein said SAPO synthesis gel has a molar composition of about 1.0 Al₂O₃:a P₂O₅:b SiO₂:c SDA(s):d H₂O where SDAs are structure directing agents, a is between about 0.01 and about 40, b is between about 0.03 and about 100, c is between about 0.2 and about 8, and d is between about 50 and about 400.

14. A porous membrane comprising SAPO-34 crystals disposed at least one of within and on a surface of a porous support and forming a SAPO-34 layer on at least one side of said porous support, and having a CO₂/N₂ separation selectivity of at least 32 for a 50/50 feed at about 22° C.

15. The membrane of claim 14, wherein said SAPO-34 layer is porous with average pore sizes of less than about 0.38 nm.

16. The membrane of claim 14, wherein said porous support is made of a material selected from the group consisting of stainless steel, carbon, glass, ceramics, and combinations thereof.

17. The membrane of claim 14, wherein said SAPO-34 layer has a thickness in a range of about 0.2 μm to about 5 μm.

18. The membrane of claim 14, wherein said porous support has pore sizes in a range of about 0.1 μm to about 5.0 μm.

19. The membrane of claim 14, wherein said SAPO-34 crystals comprise a silicaluminophosphate having a composition of SiₓAl_{y}P_{z}O₂ where x=0.01-0.98, y=0.01-0.60, and z=0.01-0.52.

20. A method for separating a first gas component from a gas mixture containing at least a first and second gas component, the method comprising the steps of:
providing a porous membrane comprising SAPO-34 crystals disposed at least one of within and on a surface of a porous support and forming a SAPO-34 layer on at least one side of said porous support, and having a CO₂/N₂ separation selectivity of at least 32 for a 50/50 feed at about 22° C., said membrane having a feed side and a permeate side and being selectively permeable to the first gas component over the second gas component;
applying a feed stream containing said first gas component and said second gas component to said feed side of said membrane; and
providing a driving force sufficient for permeation of the first gas component through the membrane, thereby producing a permeate stream enriched in the first gas component on said permeate side of said membrane.

21. The method of claim 20, wherein said first gas component is CO₂ and said second gas component is N₂.

22. The method of claim 20, wherein said feed stream is a post-combustion flue gas.
